(19) United States
(12) Patent Application Publication
(10) Pub. No.: US 2009/0113418 A1
(43) Pub. Date: Apr. 30, 2009

(54) METHOD AND APPARATUS FOR RESPONSIVE EXECUTION OF A PLATFORM-INDEPENDENT PROGRAM ON A COMPUTING PLATFORM THAT HAS NOT BEEN PROVISIONED

(75) Inventors: Chet S. Haase, Pleasanton, CA (US); Ethan R. Nicholas, Wake Forest, NC (US); Hans E. Muller, Saratoga, CA (US); Scott R. Violet, Sunnyvale, CA (US); Thorsten O. Laux, Mountain View, CA (US)

Correspondence Address: PVF -- SUN MICROSYSTEMS INC.;C/O PARK, VAUGHAN & FLEMING LLP, 2820 FIFTH STREET, DAVIS, CA, 95618-7759, US

(73) Assignee: SUN MICROSYSTEMS, INC., Santa Clara, CA (US)

(21) Appl. No.: 11/925,563

(22) Filed: Oct. 26, 2007

(51) Int. Cl. G06F 9/445

(52) U.S. Cl. 717/178

(57) ABSTRACT

Apparatus and methods are disclosed that download a vanguard-installation-bundle to a computing platform responsive to a set of platform characteristics of the computing platform. The vanguard-installation-bundle includes executable data that includes a platform-dependent set of executable data and a platform-independent set of executable data. The platform-dependent set of executable data is configured to enable execution of the platform-independent set of executable data by the computing platform. The platform-independent set of executable data includes an application program and a sufficient library. The sufficient library is a subset of a reference library. The platform-dependent set of executable data is also configured to invoke installation of the reference library on the computing platform. The method automatically executes the platform-dependent set of executable data on the computing platform and also automatically invokes installation of the reference library on the computing platform.

### BACKGROUND

1. Technical Field

The disclosed technology relates to the field of software deployment.

2. Background Art

Programming languages simplify how humans specify a program (sequence of steps or operations) that can be performed by logic implemented by one or more computers when the program is executed by the computer(s). The specification for the program's operation can be compiled into computer specific machine code and directly executed by the computer, can be interpreted by some run-time program, can be compiled into an intermediate code (for example, Java bytecode) that can be interpreted by some other program, or can be processed using some mixture of these techniques. Generally the program uses some portion of a library (for example system support procedures and/or library procedures) that implements supporting capabilities. Furthermore, most programs assume some type of “runtime” environment such as an operating system.

The Java™ programming language is a well-known platform-independent object-oriented programming language. Thus, programs written using the Java™ programming language run similarly on any supported hardware/operating-system (computing platform). Platform-independence is achieved by providing a Java-Platform for each supported hardware/operating-system. A program written in the Java language (the Java-program) can be executed by the supported hardware/operating-system platform if the supported hardware/operating-system has been provisioned with the Java-Platform (that is, the Java-Platform includes a virtual machine/operating system that supports execution of intermediate code that results from the compilation of a program written in the Java™ programming language). One skilled in the art will understand that there exist many additional details and concepts around Java. Some of these concepts include just-in-time compilers, hardware that directly executes Java bytecode, etc.

Because Java-programs do not depend on any particular computer hardware or operating system, the Java-Platform includes class libraries for use by the Java-program to provide common system-related functionality. In addition, there exist many “optional” class libraries designed to provide functionality beyond that provided by the Java-Platform. Thus, a Java Runtime Environment includes the Java-Platform and additional class libraries (the Java Libraries). Different versions of the Java-Platform are available for different computing platforms and for different uses (such as client-server applications, etc.). However, each version of the Java-Platform includes a computing platform-dependent Java Runtime Environment.

A Java-program is often downloaded to a computing platform for execution. Execution of the Java-program requires that the Java Runtime Environment be available on that computing platform (thus, that the computing platform has been provisioned). If the Java Runtime Environment is not available, the Java Runtime Environment must first be installed on that computing platform prior to execution of the Java-program (and if the installation package is not locally resident, the Java Runtime Environment is generally downloaded from the Internet).

Sun Microsystems provides a Java Runtime Environment (for example, the Java Standard Edition platform) for a number of computer hardware/operating system configurations. In addition, alternative Java environments are provided by others. Usage of the Java trademark requires that a vendor's Java Runtime Environment implementation be “compatible” and has been certified by passing a rigorous suite of validation and compatibility tests.

FIG. 1 illustrates a Java installation 100 capable of executing Java programs on a computing platform (such as is subsequently described with respect to FIG. 2). The Java installation 100 includes a reference Java-Platform 103 that incorporates a reference class library 105 and a reference Java runtime 107. The reference Java runtime 107 provides a Java Virtual Machine and a fundamental class library (not separately shown). The fundamental class library and the reference class library 105 provide services that can be used by multiple Java programs such as a Java application ‘A’ 109 and a Java application ‘B’ 111. The position of the right side of the boxes representing the Java application ‘A’ 109 and the Java application ‘B’ 111 are different to indicate that the two applications can use different services provided by the reference class library 105. Often the entire reference Java runtime 107 is needed to execute any Java program. Thus, the left side of the Java application ‘B’ 111 aligns with the left side the reference Java runtime 107. However, there are some java applications that do not use all of the reference Java runtime 107. The Java application ‘A’ 109 represents such applications and indicates that only a portion of the reference Java runtime 107 is used by the Java application ‘A’ 109 by the left side of the Java application ‘A’ 109 not being in alignment with the reference Java runtime 107. The adjective “reference” identifies that the Java-Platform has been installed using one of the released Java installers and contains the complete Java Runtime Environment and Class Library for that Java-Platform. The hashing on the reference Java runtime 107 representation indicates that the reference Java runtime 107 usually is dependent on the computing platform.

The size of the Java Runtime Environment download needed to provision a computing platform has increased over time as new features were added. This increase in size has correspondingly increased the time it takes to download and install the Java Runtime Environment needed to execute a Java-program. Thus, there can be a significant delay from the time a Java-program is requested to execute and the time it actually runs (request-run delay). The request-run delay can include the time necessary for a user to install the Java Runtime Environment on their computing platform. Similar problems will occur with other computing platform-independent technologies such as Microsoft Corporation's “.net” and Silverlight™ technologies, as well as with Adobe Corporation's Flash® technologies for rich interactive applications.

The request-run delay increase has impacted the deployment and usage of Java-programs on Desktop computers. To address the size/speed issues previously discussed and because the Java Runtime Environment is licensed under an “open-source” license, there exists the possibility that, to reduce the request-run delay, some providers of Java-programs may only include the portions of the reference Java Runtime Environment in their deployment package that are used by their particular Java-program and will leave out those portions of the reference Java Runtime Environment not used by their particular Java-program. Thus, a subsequent invocation of a Java-program will not benefit from the time taken to download such a vender's deployment bundle. Further, such practices tend to fragment the reference Java runtime 107.

One skilled in the art will understand that it is well known how to download and automatically launch executable bundles for provisioning software. It is also well understood how to use a computing platform-dependent program to trigger the installation of a software product (for example, using an executable file to trigger the installation of the Java-Platform and the subsequent launching of the software product). In addition, online installers that execute on the computing platform to download the software product and that complete the installation of the product once the package has been downloaded are well known.

The request-run delay for these approaches is significant because the program product must be completely installed (possibly requiring a download) prior to execution of the first instruction of in the down-loaded program product.

One skilled in the art will know how to automatically install the Java installation 100 prior to executing the desired program. However, this does not address the request-run delay problem. Such a one will also be aware of the discussions in the literature related to “Java Kernel” of one experimental approach for reducing the request-run delay for executing a Java-program on a computing platform that does not have an installed Java Runtime Environment (see: Nicholas, Ethan “Java Browser Edition: new name, first steps.” Aug. 31, 2007. <http://weblogs.java.net/blog/enicholas/archive/2006/09/java_browser_ed.html> (19 Sep. 2007)). The Java Kernel approach is to automatically download portions of the Java installation 100 as the Java-program executes. Thus, a sufficient portion of the reference Java runtime 107 is provided to start the Java-program and then, as each usage of a Class is attempted, if the Class is not available the Class is downloaded and made available. This approach does not result in an installation of the Java installation 100. Furthermore, each access to a non-resident Class initiates a new network connection with its corresponding delays.

It would be advantageous to reduce the request-run delay for a computing platform-independent application when the requesting computing platform does not have already have the appropriate run time environment installed and to cause installation of the appropriate run-time environment for future use.

### BRIEF DESCRIPTION OF THE DRAWINGS

FIG. 1 illustrates a typical Java installation;

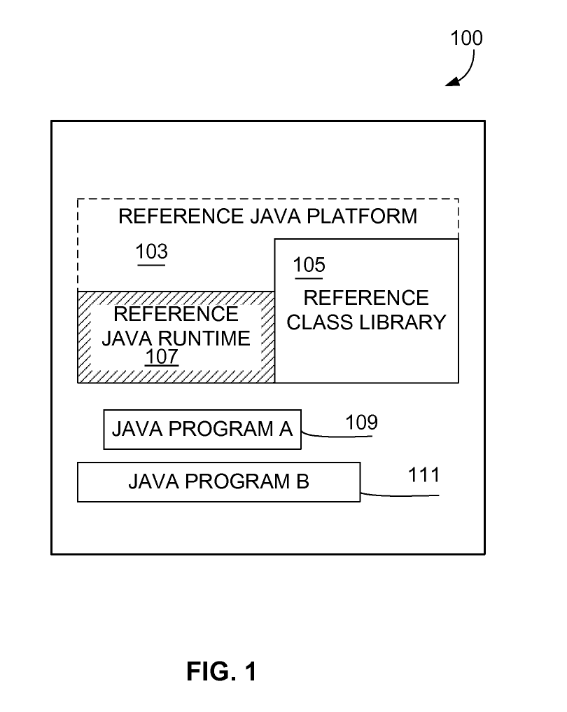

FIG. 2 illustrates a networked computer system that can be used with the disclosed technology;

FIG. 3 illustrates a Vanguard installation bundle;

FIG. 4 illustrates a Vanguard installation bundle invocation process;

FIG. 5 illustrates a Vanguard execution process; and

FIG. 6 illustrates a reference runtime environment installer thread.

### DETAILED DESCRIPTION

One aspect of the disclosed technology are computer controlled methods that download a vanguard-installation-bundle to a computing platform responsive to a set of platform characteristics of the computing platform. The vanguard-installation-bundle includes executable data that includes a platform-dependent set of executable data and a platform-independent set of executable data. The platform-dependent set of executable data is configured to enable execution of the platform-independent set of executable data by the computing platform. The platform-independent set of executable data includes an application program and a sufficient library. The sufficient library is a subset of a reference library. The platform-dependent set of executable data is also configured to invoke installation of the reference library on the computing platform. The method automatically executes the platform-dependent set of executable data on the computing platform and also automatically invokes installation of the reference library on the computing platform. Other aspects of the disclosed technology include a computer that performs the above method.

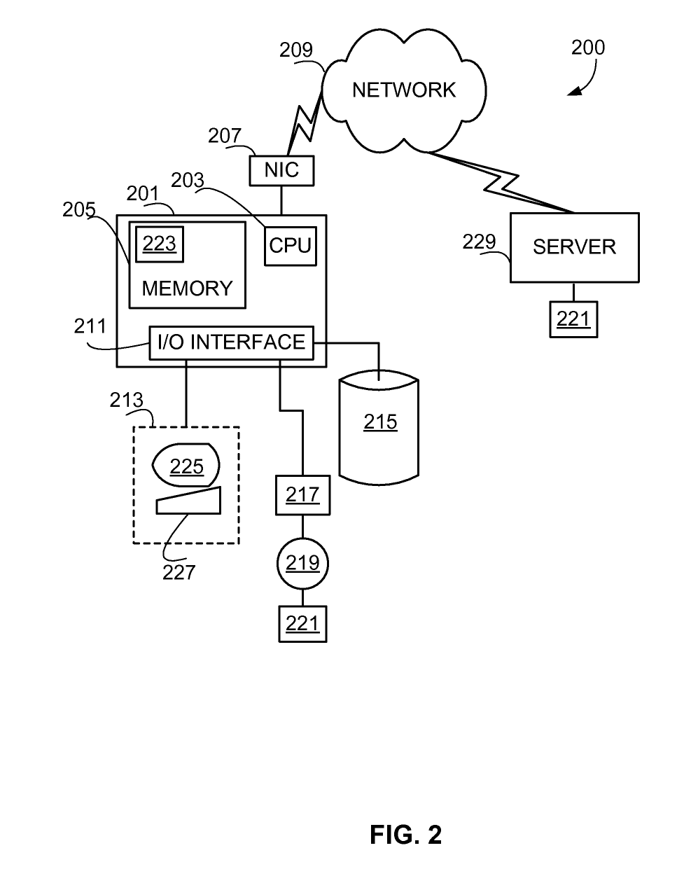

FIG. 2 illustrates a networked computer system 200 that can incorporate an embodiment of the disclosed technology. The networked computer system 200 includes a computer 201 that incorporates a CPU 203, a memory 205, and a network interface 207. The network interface 207 provides the computer 201 with access to a network 209. The computer 201 also includes an I/O interface 211 that can be connected to a user interface device(s) 213, a storage system 215, and a removable data device 217. The removable data device 217 can read a computer-usable data carrier 219 (such as a fixed or replaceable ROM within the removable data device 217 itself (not shown); as well as a computer-usable data carrier that can be inserted into the removable data device 217 itself (such as a memory stick, CD, floppy, DVD or any other tangible media) that typically contains a program product 221. The user interface device(s) 213 can include a display device 225 and a user input device 227. The storage system 215 (along with the removable data device 217), the computer-usable data carrier 219, and (in some cases the network 209) comprise a file storage mechanism. The program product 221 on the computer-usable data carrier 219 is generally read into the memory 205 as a program 223 which instructs the CPU 203 to perform specified operations. In addition, the program product 221 can be provided from devices accessed using the network 209 such as through a server computer 229. One skilled in the art will understand that the network propagates information (such as data that defines a computer program). Signals can be propagated using electromagnetic signals, visible or invisible light pulses, signals on a data bus, or signals transmitted over any wire, wireless, or optical fiber technology that allows information to be propagated from one point to another. Programs and data are commonly read from both tangible physical media (such as those listed above) and from the network 209. Thus, the network 209, like a tangible physical media, can be a computer-usable data carrier. One skilled in the art will understand that not all of the displayed features of the computer 201 need to be present for all embodiments that implement the techniques disclosed herein. Further, one skilled in the art will understand that computing platforms are ubiquitous within modem devices ranging from as cell phones to vehicles to kitchen appliances etc.

While the description of the following embodiment is cast in the context of a Java environment, one skilled in the art will understand that the disclosed technology also applies to other computing platform-independent programming environments.

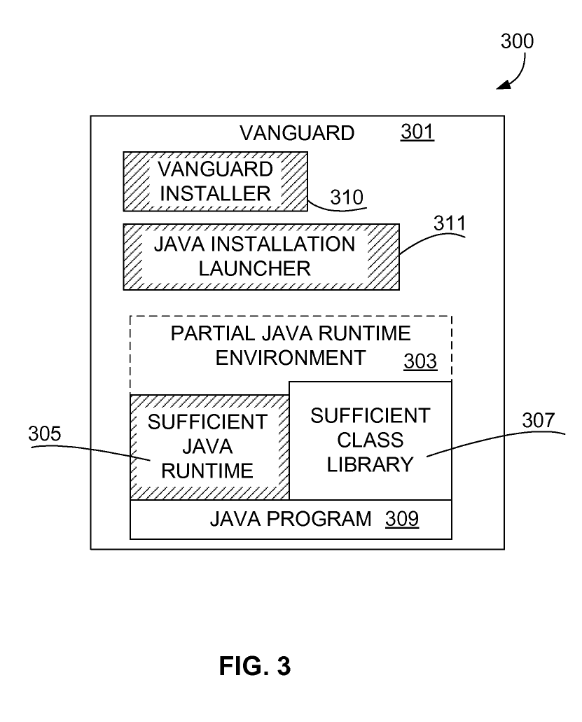

FIG. 3 illustrates a Vanguard installation bundle 300 that includes a partial Java Runtime Environment 303 containing a sufficient Java Runtime 305 and a sufficient Class Library 307, a Java program 309, a Vanguard installer 310, and a Java installation launcher 311. In some embodiments, the Vanguard installer 310 and the Java installation launcher 311 include computing platform-dependent code. One skilled in the art of Java Deployment will understand that in such embodiments the correct Vanguard installation bundle 300 for the computing platform can be identified, for example, by a browser script that examines the computing platform to determine platform characteristics and that selects a Vanguard installation bundle 300 compatible with the platform characteristics. Furthermore, the browser script can determine whether a Java Runtime Environment compatible with the Java program 309 has already been installed on the computing platform and, if so, can select a standard download for the Java program 309 instead of the Vanguard installation bundle 300 that contains the Java program 309.

Once the Vanguard installation bundle 300 is made available for installation (for example, by downloading the Vanguard installation bundle 300 from the network 209) the Vanguard installer 310 automatically executes (using techniques known in the art) to install the partial Java Runtime Environment 303, initiates execution of the Java program 309 in the context of the partial Java Runtime Environment 303, and schedules installation of a complete Java Runtime Environment (a reference execution runtime). In some embodiments, the installation of the partial Java Runtime Environment 303 and execution of the Java program 309 is automatic and transparent (if allowed by the computing platform) to the user.

Note that the Vanguard installation bundle 300 includes executable data, which includes both a platform-dependent set of executable data (that can be executed directly by the computing platform) and a platform-independent set of executable data. One portion of the platform-dependent set of executable data can be configured to enable execution of the platform-independent set of executable data by the computing platform.

This portion of the platform-dependent set of executable data can be, for example, a reference execution runtime or a sufficient execution runtime. The sufficient execution runtime is a subset of the reference execution runtime that provides sufficient support to allow the computing platform to correctly execute the platform-independent set of executable data included in the Vanguard installation bundle 300. In addition, the platform-independent set of executable data includes an application program and a sufficient library that contains the platform-independent library code needed for the application program to be executed by the computing platform/execution runtime combination. One skilled in the art will understand that a reference execution runtime can be included in the Vanguard installation bundle 300 in place of the sufficient execution runtime if needed, if the difference in size would not sufficiently affect the request-run delay, or for convenience.

The Vanguard installer 310 determines whether the executing computer has access to an appropriate Java Runtime Environment (for example, by determining whether the reference Java Runtime Environment is already installed on the computing platform). If so, the Vanguard installer 310 will cause the Java program 309 to be executed in the context of the existing Java Runtime Environment (this would generally not be needed as the browser script previously discussed should determine the platform characteristics and download the appropriate installation). However, if an appropriate Java Runtime Environment is not available to the computer, the Vanguard installer 310 will cause the Java program 309 to be executed in the context of the partial Java Runtime Environment 303 and will cause the Java installation launcher 311 to be scheduled for execution.

Thus, regardless of whether the executing computer includes a reference Java Runtime Environment, the Java program 309 starts execution in a timely fashion. However, if the executing computer does not include a reference Java Runtime Environment, the Java installation launcher 311 will invoke the standard Java Runtime Environment (JRE) installation at some subsequent time. In some embodiments, the Java Runtime Environment can be installed by automatically accessing the default Java installation web page provided by Sun Microsystems, Inc. Other embodiments can automatically access web resources download and complete the installation. In such embodiments, the Java installation launcher 311 can automatically locate a Java Runtime Environment compatible with the computing platform and, if needed, query the user for license acknowledgement. The technology for installation of the Java Runtime Environment is known as “Java Deployment” and is well understood by one skilled in the art.

Once the reference Java Runtime Environment is installed on the computing platform, the Vanguard installation bundle 300 would generally not be selected by the browser script as it would select the Java program 309 distribution suitable for a computing platform that has an installed Java-Platform.

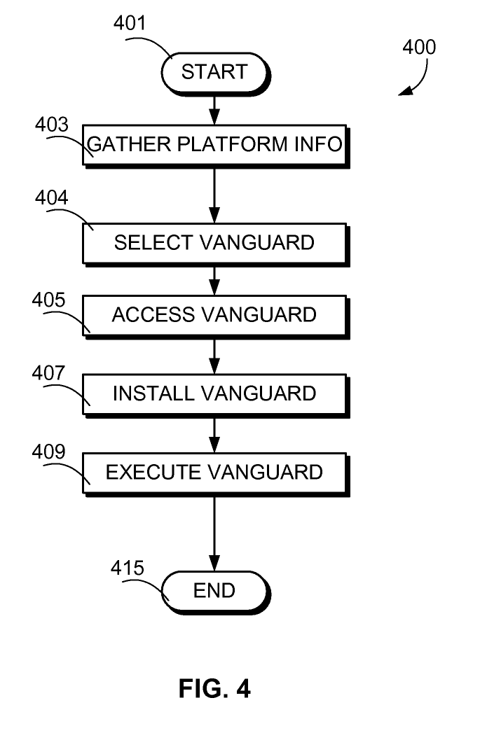

FIG. 4 illustrates a Vanguard installation bundle invocation process 400 that is initiated by activation of a hyperlink (generally by a user) that specifies a desired Java application (such as provided by the Java program 309), initiates at a ‘start’ terminal 401, and continues to a ‘gather platform characteristics’ procedure 403 that determines a set of platform characteristics of the target computing platform (and, as previously discussed, can be implemented as a browser script).

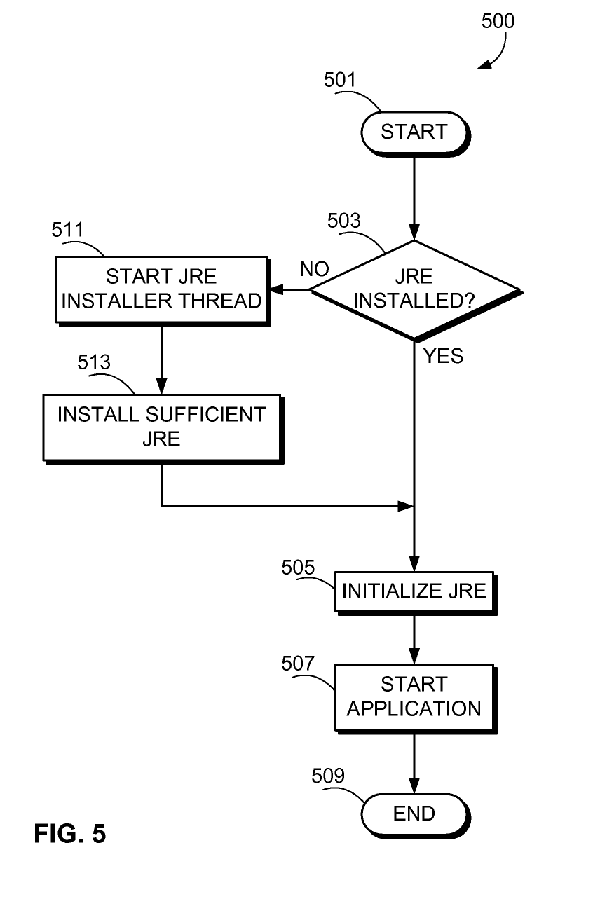

Once the set of platform characteristics is available, the Vanguard installation bundle invocation process 400 continues to a ‘select distribution’ procedure 404 that uses the set of platform characteristics to determine whether the computing platform has already installed a reference Java Runtime Environment. If so, the Java program 309 is accessed and executed in the traditional manner. However, if the computing platform has not already installed a reference Java Runtime Environment, the ‘select distribution’ procedure 404 selects the appropriate Vanguard installation bundle for the computing platform. The Vanguard installation bundle 301 is then accessed by an ‘access Vanguard installation bundle’ procedure 405 that causes the Vanguard installation bundle, which includes the Java program 309, to be made available to the invoking computing platform (for example but without limitation, by downloading the Vanguard installation bundle 300 from the Internet). Once the Vanguard installation bundle is available, an ‘install Vanguard installation bundle’ procedure 407 installs the Vanguard installer 310 and once installed, an ‘execute Vanguard installation bundle installer’ procedure 409 executes, or causes to be executed, the Vanguard installer 310 (subsequently described with respect to FIG. 5). The Vanguard installation bundle invocation process 400 completes through an ‘end’ terminal 415. In some embodiments, the ‘install Vanguard installation bundle’ procedure 407 executes transparently (if allowed by the computing platform) to the user.

FIG. 5 illustrates a Vanguard execution process 500 that can be invoked by the ‘execute Vanguard installation bundle installer’ procedure 409 of FIG. 4, that initiates at a ‘start’ terminal 501, and continues to a ‘JRE installed’ decision procedure 503. The ‘JRE installed’ decision procedure 503 evaluates whether the requesting computing platform already has installed a Java Runtime Environment compatible with the Java program 309. If so, the Vanguard execution process 500 continues to an ‘initialize JRE’ procedure 505 that prepares (if needed) the previously installed Java Runtime Environment so that it can execute the Java program 309. Once the Java Runtime Environment is initialized, a ‘start Java Program’ procedure 507 starts execution of the Java program 309. The Vanguard execution process 500 can complete through an ‘end’ terminal 509 while the Java program 309 executes.

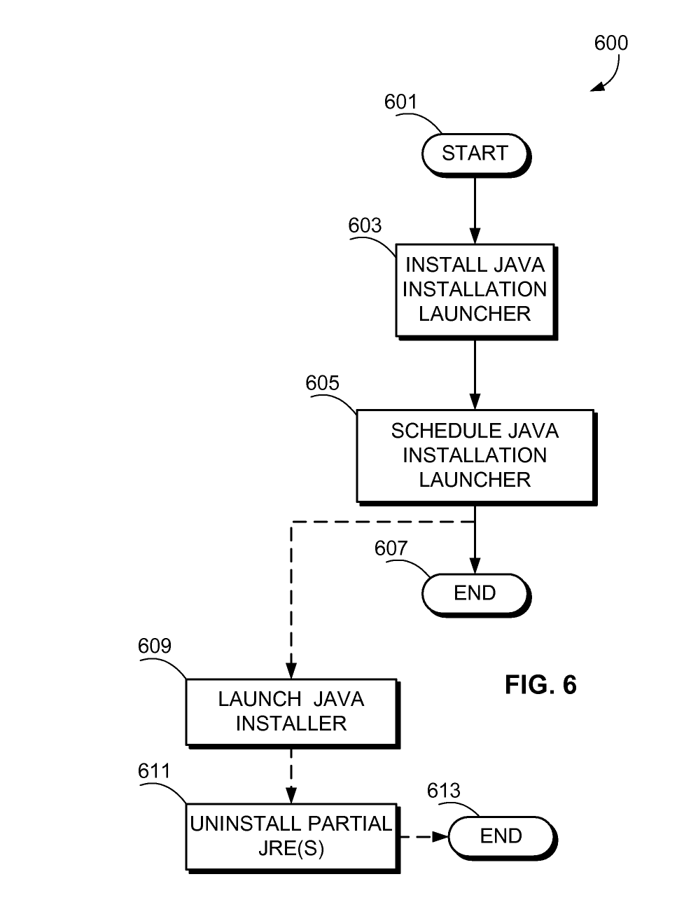

However, if the ‘JRE installed’ decision procedure 503 determines that a Java Runtime Environment is not installed on the computing platform, the Vanguard execution process 500 continues to a ‘start JRE installer thread’ procedure 511 that starts or schedules the installation of the reference Java Runtime Environment (as is subsequently described with respect to FIG. 6). An ‘install sufficient JRE’ procedure 513 installs the partial Java Runtime Environment 303 for the Java program 309, and the Vanguard execution process 500 continues to the ‘initialize JRE’ procedure 505 to initialize the sufficient Java Runtime Environment and invoke execution of the Java program 309 as have been previously described. Thus, the disclosed technology automatically causes the computing platform to execute the sufficient Java Runtime 305 portion of the platform-dependent set of executable data as well as the Java program 309 (which uses the sufficient Class Library 307). Because the Vanguard installation bundle is smaller than the reference Java Runtime Environment, the request-run delay is reduced.

In some embodiments, the Java Runtime Environment may be a system service.

One skilled in the art will understand that if the browser script is suitably robust then the ‘JRE installed’ decision procedure 503 is optional such that the Vanguard execution process 500 would unconditionally flow from the ‘start’ terminal 501 to the ‘start JRE installer thread’ procedure 511.

FIG. 6 illustrates a ‘reference runtime environment installer thread’ process 600 that can be invoked by the ‘start JRE installer thread’ procedure 511 of FIG. 5, that initiates at a ‘start’ terminal 601, and continues to an ‘install Java installation launcher’ procedure 603. The ‘install Java installation launcher’ procedure 603 installs the Java installation launcher 311 (generally transparently to the user and if allowed by the computing platform) and at a ‘schedule Java installation launcher’ procedure 605 schedules the Java installation launcher for execution. The ‘reference runtime environment installer thread’ process 600 then completes through an ‘end’ terminal 607.

Eventually (as indicated by the dotted line from the ‘schedule Java installation launcher’ procedure 605), a ‘launch Java installation launcher’ procedure 609 executes as scheduled by the ‘schedule Java installation launcher’ procedure 605 and starts installation of the reference Java Runtime Environment. Installation of the reference Java Runtime Environment includes the installation of the reference library and the reference execution runtime on the computing platform. Once the reference Java Runtime Environment is successfully installed, an ‘uninstall sufficient Java Runtime Environment’ procedure 611 can be invoked to uninstall the partial Java Runtime Environment 303 from the computing platform as it will no longer be needed because the reference Java Runtime Environment will be used to execute all subsequent Java programs. Once the partial Java Runtime Environment 303 is removed, the scheduled portion of the ‘reference runtime environment installer thread’ process 600 completes through an end terminal 613. One skilled in the art will understand that the ‘uninstall sufficient Java Runtime Environment’ procedure 611 can be invoked as a separate thread.

Because the Vanguard installation bundle provisions the computing platform with the reference Java Runtime Environment, the use of the Vanguard installation bundle encourages installation of reference installations while still reducing the request-run delay when invoking the Java program 309.

As used herein, a procedure is a self-consistent sequence of steps that can be performed by logic implemented by a programmed computer, specialized electronics or other circuitry or a combination thereof that lead to a desired result. These steps can be defined by one or more computer instructions. These steps can be performed by a computer executing the instructions that define the steps. Further, these steps can be performed by circuitry designed to perform the steps. Thus, the term “procedure” can refer (for example, but without limitation) to a sequence of instructions, a sequence of instructions organized within a programmed-procedure or programmed-function, a sequence of instructions organized within programmed-processes executing in one or more computers, or a sequence of steps performed by electronic or other circuitry, or any logic or combination of the foregoing. A general-purpose computer system executing software, specially designed circuitry, or combination of these are logics. Thus, the methods described herein can be implemented as logics. In particular, an installation logic, a discovery logic, a scheduling logic, an execution logic, a network logic, etc.

One skilled in the art will understand that the network carries information (such as informational data as well as executable data that defines a computer program). The information can also be propagated using a carrier-wave. Signals capable of propagating the information includes electromagnetic signals, visible or invisible light pulses, signals on a data bus, or signals propagated over any wire, wireless, or optical fiber technology that allows information to be transmitted over a network. Programs and data are commonly read from both tangible physical media (such as a compact, floppy, or magnetic disk) and from a network. Thus, the network, like a tangible physical media, is a computer-usable data carrier.

One skilled in the art will understand that the specific sequences of the previously described processes are illustrative and that many equivalent sequences exist. Thus, the claims are not to be limited by the specific embodiment described herein.

One skilled in the art will understand that the technology reduces the request-run delay for executing platform-independent applications when the computing platform that performs the execution of the platform-independent application has not been provisioned with the necessary run-time environment. Further, such a one will understand that the automatic installation of the reference environment does not impede the execution of the program downloaded in the Vanguard installation bundle because the Vanguard installation bundle contains the required support for that particular application and can execute prior to the installation of the reference environment.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

What is claimed follows:

1. A computer controlled method comprising:
downloading a vanguard-installation-bundle to a computing platform responsive to a set of platform characteristics of said computing platform, said vanguard-installation-bundle comprising executable data, said executable data comprising a platform-dependent set of executable data and a platform-independent set of executable data, said platform-dependent set of executable data configured to enable execution of said platform-independent set of executable data by said computing platform, said platform-independent set of executable data comprising an application program and a sufficient library, said sufficient library a subset of a reference library, said platform-dependent set of executable data further configured to invoke installation of said reference library on said computing platform;
automatically executing said platform-dependent set of executable data by said computing platform; and
automatically invoking installation of said reference library on said computing platform.

2. The computer controlled method of claim 1, further comprising determining said set of platform characteristics for said computing platform.

3. The computer controlled method of claim 1, further comprising installing said reference library on said computing platform.

4. The computer controlled method of claim 1, wherein said reference library is a java-class-library.

5. The computer controlled method of claim 1, wherein said platform-dependent set of executable data comprises a sufficient execution runtime, and said sufficient execution runtime is a subset of a reference execution runtime.

6. The computer controlled method of claim 5, further comprising installing said reference execution runtime on said computing platform.

7. The computer controlled method of claim 6, wherein said reference execution runtime is a java-runtime.

8. An apparatus having a processing unit and a memory coupled to said processing unit, the apparatus comprising:
a network logic configured to download a vanguard-installation-bundle to a computing platform responsive to a set of platform characteristics of said computing platform, said vanguard-installation-bundle comprising executable data, said executable data comprising a platform-dependent set of executable data and a platform-independent set of executable data, said platform-dependent set of executable data configured to enable execution of said platform-independent set of executable data by said computing platform, said platform-independent set of executable data comprising an application program and a sufficient library, said sufficient library a subset of a reference library, said platform-dependent set of executable data further configured to invoke installation of said reference library on said computing platform;
an execution logic configured to automatically execute said platform-dependent set of executable data by said computing platform; and
a scheduling logic configured to automatically invoke installation of said reference library on said computing platform.

9. The apparatus of claim 8, further comprising a discovery logic configured to determine said set of platform characteristics for said computing platform.

10. The apparatus of claim 8, further comprising an installation logic configured to install said reference library on said computing platform responsive to the scheduling logic.

11. The apparatus of claim 8, wherein said reference library is a java-class-library.

12. The apparatus of claim 8, wherein said platform-dependent set of executable data comprises a sufficient execution runtime, and said sufficient execution runtime is a subset of a reference execution runtime.

13. The apparatus of claim 12, further comprising an installation logic configured to install said reference execution runtime on said computing platform responsive to the scheduling logic.

14. The apparatus of claim 13, wherein said reference execution runtime is a java-runtime.
